(19) United States
(12) Patent Application Publication
(10) Pub. No.: US 2007/0270327 A1
(43) Pub. Date: Nov. 22, 2007

(54) Dryer-added fabric care articles imparting fabric feel benefits

(75) Inventors: Terri Anne Beck, Cincinnati, OH (US); Leslie Dawn Waits, Cincinnati, OH (US); George Kavin Morgan, Hamilton, OH (US); Renae Dianna Fossum, Middletown, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company

(21) Appl. No.: 11/544,206

(22) Filed: Oct. 6, 2006

Related U.S. Application Data
(60) Provisional application No. 60/802,410, filed on May 22, 2006.

(51) Int. Cl. C11D 3/00

(52) U.S. Cl. 510/515

(57) ABSTRACT

Dryer-added fabric conditioning articles that comprise microcapsules provide a unique fabric feel benefit to treated fabric.

### CROSS REFERENCE TO RELATED APPLICATION

This application claims the benefit of U.S. Provisional Application No. 60/802,410, filed May 22, 2006.

### FIELD OF INVENTION

The present invention relates to dryer-added articles that comprise microcapsules.

### BACKGROUND OF THE INVENTION

Consumers are continually expressing the desire to not only have scent experiences on their fabrics but are becoming more discriminating as to the range of different fabric feel benefits they desire. Current fabric softeners, especially dryer sheets, fall short of fulfilling this consumer need. Many fabric softener sheets leave a dry, fluffy feeling on fabric whereas some users would prefer a “silky” feel. There is a continuing need to provide a dryer-added article that provide a suitable scent experience but also a different fabric feel benefit not provided by those dryer sheet products currently in the marketplace.

### SUMMARY OF THE INVENTION

The present invention attempts to addresses this and other needs in a cost effective manner. In a first aspect of the invention, a dryer-added fabric conditioning article comprises from about 10 mg to about 100 mg of perfume encapsulated within a perfume microcapsule. Another aspect of the invention provides a dryer-added article comprising a formaldehyde scavenger.

Methods and kits for using the articles of the present invention are also provided.

### BRIEF DESCRIPTION OF THE DRAWINGS

While the specification concludes with claims particularly pointing out and distinctly claiming the invention, it is believed that the invention will be better understood from the following description of preferred embodiments which is taken in conjunction with the accompanying drawings in which:

FIG. 1 is a graphical representation of the extraction energy of all treatments tested.

### DETAILED DESCRIPTION OF THE INVENTION

The present invention relates, in part, on the surprising discovery that a potentially unique “feel” benefit is imparted to fabric treated with friable perfume microcapsules versus current dryer sheet technology. Recent testing to understand the performance of dryer sheets containing friable perfume microcapsules resulted in a surprising “feel” on fabric that is noticeably (or uniquely) different from conventional cyclodextrin dryer sheet technology. This unique friable perfume microcapsule imparted “feel” on fabric is a surface lubricity often described by consumers as a silky, slippery type of softness. This silky, slippery softness is distinguished from current BOUNCE® which contains cyclodextrin technology and imparts a softness that is often described as is a somewhat drier, more cottony feel.

Without wishing to be bound by theory, these silky fabric feel benefits may be attributed to the “ball bearing” effect of the friable microcapsule, or the deposition of perfume by the perfume microcapsule, wherein the perfume acts as a lubricant, or a combination thereof.

This discovery is based, in part, upon data that suggests that there appears to be differences in the extraction energies among the six treatments tested using an Extraction Energy Evaluation Test Method (EETM) using a Phabrometer.

The EETM is described. Fabric is cut in the shape of a circle and placed between 2 rings. The top ring is weighted and can be varied based on fabric type. A small probe pushes the fabric through the hole in the ring (perpendicular to the fabric surface). The instrument records the force (as voltage) needed to push the fabric through the ring as a function of time. The extraction energy is the area under the voltage-time curve plot.

Briefly, the EETM suggests that it takes less energy to extract cotton terry cloth dried with BOUNCE sheets containing perfume microcapsules (“PMCs”) as compares to cloths dried with BOUNCE sheets without PMCs. The results of the EETM are summarized in Table 1. The lower the extraction energy, the more lubricous or “silky” the fabric likely feels.

TABLE 1

| Treatment | Extraction Energy |
|---|---|
| Current BOUNCE Outdoor Fresh | 54 |
| Dryer Sheet (control) | |
| Appleton¹ PMC @ 55 mg/sh^{a} | 54 |
| Appleton PMC @ 65 mg/sh | 51 |
| Appleton Beauty PMC @ 75 mg/sh | 50 |
| Quest² PMC @ 65 mg/sh | 51 |
| IFF³ PMC @ 65 mg/sh | 50 |

¹Appleton, melamine formaldehyde microcapsule.
²Quest International: Wizard Perfume Microcapsules via Reed Pacific, melamine formaldehyde microcapsule.
³International Flavor & Fragrances: Everlast, melamine formaldehyde microcapsule.
^{a}The term “mg/sh” means the amount of perfume encapsulated by the perfume microcapsule as contained in the dryer sheet as a whole.

The data suggests, per Table 1, that upon reaching a concentration of 65 mg of perfume encapsulated by the PMC, per dryer sheet, the extraction energy is lower that exhibited by a current BOUNCE® sheet. Without wishing to be bound by theory, the lower extraction energy is indicative of the silky feel imparted to fabric.

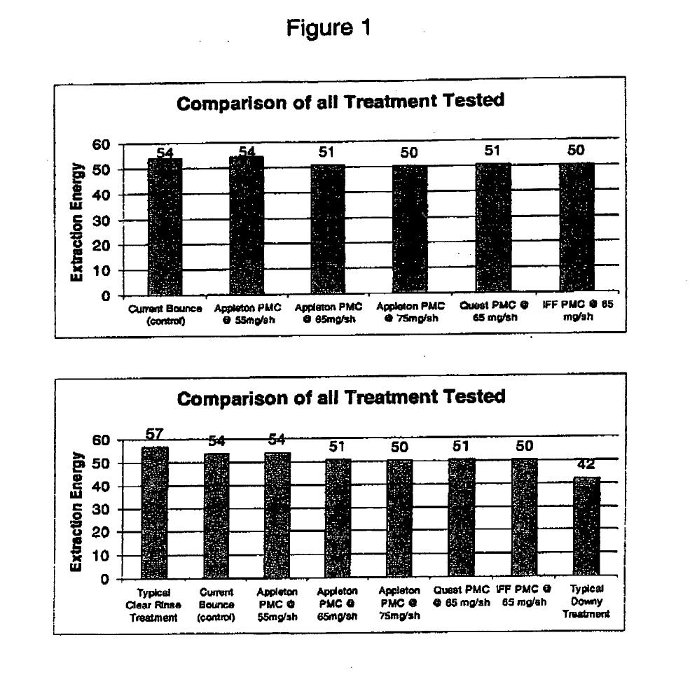

FIG. 1 is a bar graph of the different samples tested by way of the EETM. Interestingly, the dryer sheet comprising higher amounts of perfume encapsulated by the PMC per dryer sheet exhibited values closer to the rinse-added liquid fabric softener DOWNY®. In other words, dryer sheet within a preferred range of friable PMC may provide a liquid fabric softener feel via a tumble dryer.

The data also suggests that the fabric feel benefit imparted by friable PMC applies likely equally to the three different PMC suppliers tested.

### Perfume Microcapsules

The term “microcapsule” is used herein the broadest sense and includes the encapsulation of perfume or other materials or actives in small capsules (i.e., microcapsules), typically having a diameter less than 300 microns. Typically, these microcapsules comprise a spherical hollow shell of water insoluble material, typically polymer material, within which the active material, such as perfume, is contained. Microcapsules are described in the following references: US 2003/215417 A1; US 2003/216488 A1: US 2003/158344 A1; US 2003/165692 A1; US 2004/071742 A1; US 2004/071746 A1; US 2004/072719 A1; US 2004/072720 A1; EP 1,393,706 A1; US 2003/203829 A1; US 2003/195133 A1; US 2004/087477 A1; US 2004/0106536 A1; U.S. Pat. No. 6,645,479; U.S. Pat. No. 6,200,949; U.S. Pat. No. 4,882,220; U.S. Pat. No. 4,917,920; U.S. Pat. No. 4,514,461; US RE 32,713; U.S. Pat. No. 4,234,627.

Microcapsules may be prepared using a range of conventional methods known to those skilled in the art for making shell capsules, such as Interfacial polymerization, and polycondensation. See e.g., U.S. Pat. No. 3,516,941, U.S. Pat. No. 4,520,142, U.S. Pat. No. 4,528,226, U.S. Pat. No. 4,681,806, U.S. Pat. No. 4,145,184; GB 2,073,132; WO 99/17871; and MICROENCAPSULATION: Methods and Industrial Applications Edited by Benita and Simon (Marcel Dekker, Inc. 1996). It is recognized; however, that many variations with regard to materials and process steps are possible. Non-limiting examples of materials suitable for making shell of the microcapsule include urea-formaldehyde, melamine-formaldehyde, phenol-formaldehyde, gelatin, polyurethane, polyamides.

In one embodiment of the invention, the shell of the microcapsules comprises an aminoplast resin. A method for forming such shell capsules includes polycondensation. Aminoplast resins are the reaction products of one or more amines with one or more aldehydes, typically formaldehyde. Non-limiting examples of suitable amines include urea, thiourea, melamine and its derivates, benzoguanamine and acetoguanamine and combinations of amines. Suitable cross-linking agents (e.g., toluene diisocyanate, divinyl benzene, butanediol diacrylate etc.) may also be used and secondary wall polymers may also be used as appropriate, e.g. anhydrides and their derivatives, particularly polymers and co-polymers of maleic anhydride as disclosed in US 2004/0087477 A1. In another embodiment, the shell of the microcapsules comprises urea-formaldehyde; melamine-formaldehyde; or combinations thereof.

The microcapsules of the present invention, in one embodiment, are friable in nature. Friability refers to the propensity of the microcapsules to rupture or break open when subjected to direct external pressures or shear forces. For purposes of the present invention, the microcapsules utilized are “friable” if, while attached to fabrics treated therewith, they can be ruptured by the forces encountered when the capsule-containing fabrics are manipulated by being worn or handled (thereby releasing the contents of the capsule). In another embodiment, the microcapsule is a moisture-activated microcapsule such as beta-cyclodextrin. In yet another embodiment, the microcapsules are combinations of friable microcapsules and moisture-activated microcapsules.

In one embodiment, the shell capsules typically have a mean diameter in the range 1 micrometer to 100 micrometers, alternatively from 5 micrometers to 80 microns, alternatively from 10 micrometers to 75 micrometers, and alternatively between 15 micrometers to 50 micrometers. The particle size distribution can be narrow, broad or multimodal.

In another embodiment, microcapsules vary in size having a maximum diameter between about 5 microns and about 300 microns, alternatively between about 10 microns and about 200 microns. As the capsule particle size approaches 300 microns, e.g. 250 microns), a reduction in the number of capsules entrained in the fabric may be observed.

In another embodiment, the capsules utilized in the present invention generally have an average shell thickness ranging from about 0.1 micron to 50 microns, alternatively from about 1 micron to about 10 microns.

Suppliers of microcapsules may include International Flavors & Fragrances (IFF), Quest International (Quest) via Reed Pacific, and Appleton. An example of a suitable microcapsule for purposes of the present invention includes Perfume Microcapsules (PMCs) from Appleton. Other examples may include WIZARD from Reed Pacific, and EVERLAST from IFF. For a preferred embodiment, the shell is formed by cross-linking aldehydes and amine functionalities. In one embodiment, the encapsulated blooming perfume composition may, in one embodiment, comprise from about 3 to about 300 different perfume ingredients, preferably with minimal modifiers which include viscosity or hydrophobicity modifiers. Typical viscosity modifiers include, but not limited to, silicone oil, gums, and waxes. Typical hydrophobic modifiers include, but not limited to, isopropyl myristate, mineral oil, dipropylenemethyl either (DPM). Such modifiers may be used at less than 50%, alternatively less than 40%, alternatively less than 30%, alternatively less than 20%, alternatively less than 10%, alternatively less than 5%, alternatively less than 1%, alternatively about 0%, alternatively at least 0.1% but not greater than 50%, by weight of total perfume composition. Without wishing to be bound by theory, the overuse of modifiers reduces the efficiency of the scent experience imparted by the perfume microcapsules of the present invention.

The friable microcapsules of the present invention are distinguished from moisture-activated microcapsules, such as those capsules comprising of cyclodextrin that burst upon contact with moisture; a wax comprising microcapsule such as those described in U.S. Pat. No. 5,246,603; and starch-based microcapsule also described in U.S. Pat. No. 5,246,603.

In one embodiment, the PMC encapsulates “blooming” perfume ingredients. Non-limiting examples of blooming perfume ingredients that are useful in the articles of the present invention are given in U.S. Pat. Pub. No. 2005/0192207 A1, published Sep. 1, 2005, ¶¶29-31. Other perfume ingredients that may be encapsulated by the microcapsules of the present invention include those described in U.S. Pat. Pub. No. 2005/0192207 A1, published Sep. 1, 2005, ¶36.

### Amount of PMC

One aspect of the present invention provides from about 10 mg to about 100 mg of perfume encapsulated by the PMC in a single use dryer sheet. Alternatively, the article comprises from about 40 mg to about 100 mg, or 65 mg to about 100 mg, or 70 mg to about 100 mg of perfume encapsulated by the friable PMC of the present invention. Multiple use articles (those articles that can be used more than once in a dryer) will have much more encapsulated PMC; however, these multiple use article will deposit from about 8 mg to about 80 mg of perfume encapsulated by PMC to laundry per dryer. An example of a multiple use article include those described in U.S. Pat. Appl. No. 2003/0195130 A1.

It is observed that dyer sheets comprising friable PMC, deliver about 80% of the PMC to fabric in an unburst form, by weight of unburst PMC contained in the dryer sheet. The amount of actual microcapsules will depend on a number factors, including the perfume loading of the PMC (how much perfume can be encapsulated by the PMC0, the size and type of friable microcapsule, and what the efficiency is the article to deliver friable PMC to fabric during a drying cycle. A dryer sheet is typically about 58 inches².

There are a number of ways of calculating the amount of perfume encapsulated by PMC. One such method includes a solvent extraction approach. In such an approach, the coating of the dryer sheet is extracted from the substrate (e.g., non-woven sheet) with a warm solvent suitable for such extraction, including, but not limited to a solution of isopropanol, hexane, methanol, or combinations thereof. Multiple extractions may be needed. The extract is dried and weighed. The extracted sheet is also weighed. The difference in sheet weight before and after extraction is the coating weight. Thereafter, the extract is filtered to isolate the PMC. The isolated PMC is dried and weighed. The weight of the isolated PMC divided by the weight of the coating mix multiplied by 100 is the % of PMC in the coating mix. The use of gas chromatography/mass spectrometry can confirm the presence and identify perfume encapsulated by the microcapsule. In turn the presence of the microcapsule can be confirmed with the use of scanning electron microscopy. Infrared (IR) may be suitable to identify the composition of the shell of the microcapsule.

### Dryer Added Articles

The perfume microcapsules of the present invention are deposited on to fabric by using the articles of the present invention in an automatic laundry dryer. The term “dryer-added article” is used herein in the broadest sense to include any article that is suitable to delivering the perfume microcapsules, and the blooming perfume compositions encapsulated therein, of the present invention to fabric in an automatic laundry drying machine.

Examples of dryer-added articles include those described in U.S. Pat. Nos. 3,989,63; 4,000,340; 4,055,248; 4,073,996; 4,022,938; 4,764,289; 4,808,086; 4,103,047; 4,014,432; 3,736,66; 3,701,202; 3,634,947; 3,633,538, 3,435,537; 6,604,297; and 6,787,510. See also International Patent Publication Nos. WO 00/27991; and WO 00/65141.

In one embodiment, the article comprises a substrate. An example of a substrate includes a sheet. The sheet may be chosen from a paper, woven, or non-woven sheet, such as those described in U.S. Pat. No. 3,686,025. A substrate comprising a sponge is yet another example. An example of a non-woven dryer sheet is one from BBA Fiber Web. A commercially available example of an article comprising a substrate and fabric conditioning composition includes a dryer sheet such as those sold under the trademark BOUNCE.

In a preferred embodiment, the dryer-added article further comprises a fabric conditioning composition. A “fabric conditioning composition” is herein defined as a composition that imparting one or more fabric care benefits such as softening, anti-static, color protection, etc., to fabrics. In one embodiment, the fabric care composition is disposed on the substrate (e.g., such as in a dryer sheet). In an alternative embodiment, the article of the present invention comprises a fabric condition composition without a substrate. Examples include dispensing the fabric conditioning composition, along with the perfume microcapsules of the present invention, through a dispenser affixed to the outside surface of the dryer or inside surface of the dryer barrel or inside door, or integral to the dryer itself.

Other examples of articles that may comprise the microcapsules of the present invention include those multiple use dryer-added described in U.S. Pat. Pub. Nos. 2005/0192207; 2003/0192197; and 2003/0195130. In one embodiment, the article comprises a dryer-added, multiple use, article that is releasable attached to an inside surface of a dryer, preferably the dryer barrel, more preferably the fin of the dryer barrel. An example of a commercially available dryer bar is the X-STATIC in-dryer fabric softening bar from Ecolab, Inc.

### Fabric Conditioning Composition

The articles of the present invention may comprise a fabric conditioning composition. In turn, a fabric conditioning composition may comprises one or more fabric conditioning actives. Examples of fabric conditioning actives may include a fabric softening active and/or an antistatic active. The fabric care composition may comprise from at least about 0.001% to about 99.99%, alternatively about 1% to about 90%, alternatively from about 10% to about 50%, alternatively from about 15% to about 40% of one or more fabric conditioning actives by weight of the fabric care composition. In turn, the dryer-added article may comprise from at least about 0.001% to about 99.99%, alternatively about 1% to about 90%, alternatively from about 10% to about 50%, alternatively from about 15% to about 40% of a fabric conditioning composition by weight of the article.

The fabric softening actives can be one or a mixture of a quaternary ammonium compound, a tertiary amine and or its salts, an ethoxylated fatty material, a fatty acid, any fatty acid derivative, or a mixture thereof. Examples of fabric softening actives that may be useful in the articles are the compositions described in U.S. Pat. Nos. 4,103,047; 4,237,155; 3,686,025; 3,849,435; 4,073,996; and U.S. Pat. Publ. No. 2003/0195130, ¶¶14-17.

In one embodiment, the fabric softening active is chosen from at least one of the following: a quaternary ammonium compound as one described in U.S. Pat. No. 6,787,510, col. 4, line 12 et seq.; or a tertiary amine, as described in id. at col. 7, line 31 et seq.; or a nonionic softening active, id. at col. 8, line 63 et seq.; or a fatty acid, id. at col. 10, line 63 et seq.; or combinations thereof.

### Formaldeyde Scavengers

One aspect of the invention provides for a composition comprising a formaldehyde scavenger. The term “formaldehyde scavenger” is used herein the broadest sense to include any compound that reduces the level of free formaldehyde in a composition of the present invention, provided the formaldehyde scavenger is safe for humans and does not include ammonia, ethylene urea, tryptophan, 5-hydroxytryptophan, hydroxyl amine, hydroxylamine sulfate, barbituric acid.

This aspect of the present invention is based, in part, upon the discovery that the use of certain formaldehyde scavengers in fabric care compositions, particularly those fabric care compositions that comprise microcapsules (e.g., PMC), may reduce the level of free formaldehyde in the composition. Without wishing to be bound by theory, free formaldehyde may be emitted by the use of certain microcapsules over time. It is thought that the shell material used to manufacture the shell of the microcapsule may be responsible for the formation of free formaldehyde. For example, these shell materials include melamine-formaldehyde, urea-formaldehyde, pheno-formaldhyde, or other condensation polymers with formaldehyde. Nevertheless formaldehyde based resins such as melamine-formaldehyde or urea-formaldehyde resins are especially attractive for perfume encapsulation due to their wide availability and reasonable cost. However, these microcapsules may emit formaldehyde. There is a need to minimize the emission or potential emission of free formaldehyde.

The term “free formaldehyde” means those molecular forms in aqueous solution capable of rapid equilibration with the native molecule, i.e., H₂CO, in the headspace over the solution. This includes the aqueous native molecule; its hydrated form (methylene glycol; (HOCH₂OH)); and its polymerized hydrated form (HO)CH₂O)ₙH). These are described in detail in a monograph by J. F. Walker (Formaldehyde ACS Monograph Series No. 159 3rd Edition 1964 Reinhold Publishing Corp.).

Any art-accepted method may be used to determine the amount or moles of free formaldehyde (in the perfume microcapsule composition or in the fabric care composition). Other methods may include the EPA method EPA 8315A, Determination of Carbonyl Compounds by High Performance Liquid Chromatography, and High-Performance Liquid Chromatographic Determination of Free Formaldehyde in Cosmetics Preserved with Dowicil 200, Journal of Chromatography, 502 (1990), pages 193-200. One example includes the following: formaldehyde is analyzed by means of room temperature derivatization with 2,4 dinitrophenyl hydrazine (DNPH) prior to a chromatographic separation using Reversed Phase Chromatography with UV/Visible spectrophotometric detection (wavelength setting at 365 nm). Calibration is performed through “External Standard calibration” with reference formaldehyde solution made up from commercially available 36-37% formaldehyde solution. Activity of the formaldehyde standard material can be determined via redox titration.

In one embodiment, the formaldehyde scavenger is chosen from: sodium bisulfit, urea, cysteine, cysteamine, lysine, glycine, serine, carnosine, histidine, glutathione, 3,4-diaminobenzoic acid, allantoin, glycouril, anthranilic acid, methyl anthranilate, methyl 4-aminobenzoate, ethyl acetoacetate, acetoacetamide, malonamide, ascorbic acid, 1,3-dihydroxyacetone dimer, biuret, oxamide, benzoguanamine, pyroglutamic acid, pyrogallol, methyl gallate, ethyl gallate, propyl gallate, triethanol amine, succinamide, thiabendazole, benzotriazol, triazole, indoline, sulfanilic acid, oxamide, sorbitol, glucose, cellulose, poly(vinyl alcohol), poly(vinyl amine), hexane diol, ethylenediamine-N,N′-bisacetoacetamide, N-(2-ethylhexyl)acetoacetaminde, N-(3-phenylpropyl)acetoacetamide, lilial, helional, melonal, triplal, 5,5-dimethyl-1,3-cyclohexanedione, 2,4-dimethyl-3-cyclohexenecarboxaldehyde, 2,2-dimethyl-1,3-dioxan-4,6-dione, 2-pentanone, dibutyl amine, triethylenetetramine, benzylamine, hydroxycitronellol, cyclohexanone, 2-butanone, pentane dione, dehydroacetic acid, chitosan, or a mixture thereof. In another embodiment, the ketoester or ketoamide is chosen from a β-ketoester or a β-ketoamide, respectively. Non-limiting examples include ethyl acetoactamide or methyl acetoacetate ester (aldrich). Another example includes 16-diketene sizing agents (the diketene can ring open with any alcohol to yield a ketoester) such as those from Hercules. In yet another embodiment, the amount of scavenger in the fabric care composition comprises from about 0.01% to about 0.8%, alternatively from about 0.03% to about 0.4%, alternatively from about 0.065% to about 0.25%, by weight of the fabric conditioning composition. Further details of formaldehyde scavengers are described in U.S. patent application Ser. No. 11/351718, filed Feb. 10, 2006 (P&G Case 10301).

### Optional Components

The fabric conditioning composition may further comprise optional components used in textile treatment compositions including one or more of the following: soil release polymer, anti-oxidants, colorants, preservatives, optical brighteners, opacifiers, stabilizers such as guar gum and polyethylene glycol, anti-shrinkage agents, anti-wrinkle agents, soil release agents, fabric crisping agents, reductive agents, spotting agents, germicides, fungicides, anti-corrosion agents, antifoam agents, and the like. In one embodiment, the fabric conditioning composition is free or substantially free of any one or more of the above-identified optional components.

### Kits and Methods

One aspect of the invention provides for a kit comprising an article of the present invention, optionally comprising instructions, wherein preferably the instructions instruct the user to administer the article inside an automatic laundry dryer.

Another aspect of the invention provides for a method of treating fabric comprising the step of administering an article of the present invention into an automatic laundry dryer.

### Different Blooming Perfume Composition within Same Dryer-Added Article

One aspect of the invention provides for a dryer-added article comprising a perfume microcapsule of the present invention encapsulated more than one type of blooming perfume compositions. For example, one embodiment of the invention provides for an article that comprises both a first microcapsule encapsulating a first blooming perfume composition and a second microcapsule encapsulating a second blooming perfume composition, wherein the first blooming perfume composition is different from the second blooming perfume composition. Another embodiment provides yet a third microcapsule encapsulating a third blooming perfume composition, wherein the third blooming perfume composition is different from the first and second blooming perfume compositions. By providing different blooming perfume compositions within the same dryer-added article, the consumer can experience multiple scent types within the same article which allows for a more holistic product experience. By separating these blooming perfume compositions this holistic product experience may not have otherwise by achieved if some of the perfume ingredients in the respective blooming perfume compositions are not compatible with each other—at least in the encapsulation environment of the perfume microcapsule.

### EXAMPLES

### Example 1

### Lab Scale Incorporation of Perfume Microcapsules in a Dryer Sheet is Described

A fabric conditioning composition is melted at a temperature sufficient for the composition to attain a molten state. Next, a desired amount of perfume microcapsules (PMC) of the present invention (in addition to any other fabric care ingredient(s) including but not limited to neat perfume(s), other perfume technology(s), &/or fabric care technologies) is added to the molten fabric conditioning composition and wherein the composition is mixed until a homogenous mixture is obtained. Thereafter, the homogenous mixture is poured onto a heated surface with a temperature that will allow the homogenous mixture to stay in a molten state. The temperature on the heated surface may remain at the desired, elevated level, by heating the surface with, for example, steam. Next, the molten, homogenous mixtures is impregnated or disposed onto a substrate, such as a non-woven sheet (such as in a BOUNCE dryer sheet substrate), at the desired weight amount. Finally, the substrate is removed from the surface to allow fabric conditioning composition mixture to achieve a solid state.

Examples of dryer sheet formulations suitable for use on non-woven dryer sheets include Examples A-C:

| | Example A | Example B | Example C |
|---|---|---|---|
| Ingredients | Wt. % | Wt. % | Wt. % |
| C Salt^{(a)} | 28.9 | 28.9 | 28.9 |
| KRA^{(b)} | 57.8 | 57.8 | 57.8 |
| Clay^{(c)} | 5.8 | 5.8 | 5.8 |
| Neat Perfume A^{(d)} | 0.6 | 0.6 | 0.6 |
| Perfume Microcapsule^{(e)} | 6.9 | — | — |
| (Appleton) with encapsulated | | | |
| blooming perfume | | | |
| composition^{(f)} | | | |
| Perfume Microcapsule^{(g)} | — | 6.9 | — |
| (Quest) with encapsulated | | | |
| blooming perfume | | | |
| composition^{(f)} | | | |
| Perfume Microcapsule^{(h)} (IFF) | — | — | 6.9 |
| with encapsulated blooming | | | |
| perfume composition^{(f)} | | | |
| Total | 100 | 100 | 100 |

^{(a)}Dimethyl Stearyl Amine & triple pressed Stearic Acid. Company: Peter Kramer
^{(b)}Di(tallow oxyethyl)hydroxyethylmethylammoniummethylsulfate. Company: Stepan
^{(c)}Calcium Monomorilonite. Company: Southern Clay
^{(d)}Frangrance. Company: Internally developed (Procter & Gamble) or externally such as Firmenich
^{(e)}Perfume Microcapsule Composition. Company: Appleton
^{(f)}Blooming Perfume Composition. Company: Internally developed (Procter & Gamble) or externally such as Firmenich
^{(g)}Perfume Microcapsule Composition. Company: Quest International via Reed Pacific
^{(h)}Perfume Microcapsule Composition. Company: International Flavors & Fragrances

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and Claims, are be weight and all numerical limits are used with the normal degree of accuracy afforded by the art, unless otherwise specified.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the DETAILED DESCRIPTION OF THE INVENTION are, in the relevant part, incorporated herein by reference; the citation of any document is not to be construed as an admission that it is prior art with respect to the present invention. To the extent that any meaning or definition of a term or in this written document conflicts with any meaning or definition in a document incorporated by reference, the meaning or definition assigned to the term in this written document shall govern.

Except as otherwise noted, the articles “a,” “an,” and “the” mean “one or more.”

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A dryer-added fabric conditioning article comprising:
a) a substrate in the form of a sheet;
b) a fabric conditioning composition; and
c) from about 10 mg to about 100 mg of perfume encapsulated in a friable perfume microcapsule.

2. (canceled)

3. (canceled)

4. (canceled)

5. The dryer-added fabric conditioning article of claim 1, wherein said friable perfume rnicrocapsule comprises an arninoplast resin.

6. The dryer-added fabric conditioning article of claim 5, wherein said friable perfume micmocapsule comprises a mean diameter from about 1 micrometer to about 100 micrometers.

7. The dryer-added fabric conditioning article of claim 5, wherein said friable perfume microcapsule comprises a maximum diameter from about 5 microns to about 300 microns.

8. The dryer-added fabric conditioning article of claim 5, wherein said friable perfume microcapsule comprises an average shell thickness from about 0.1 micron to about 50 microns.

9. The dryer-added fabric conditioning article of claim 5, further comprising less than about 50% by weight of said perfume, of a viscosity modifier.

10. The dryer-added fabric conditioning article of claim 5, further comprising less than about 50% by weight of said perfinne, of a bydrophobicity modifier.

11. The dryer-added fabric conditioning article of claim 5, further comprising one or more fabric conditioning actives.

12. The dryer-added fabric conditioning article of claim 5, further comprising a moisture-activated perfume microcapsule.

13. The dryer-added fabric conditioning article of claim 5, wherein said perfwne comprises:
a) a first blooming perftune ingredient encapsulated in a first friable perfume microcapsule;
b) optionally, a second blooming perfume composition encapsulated in a second friable perfume microcapsuic, wherein said first blooming perfume composition is different from said second blooming perfume composition; and
c) optionally, a third blooming perfume composition encapsulated in a third friable perfume microcapsule, wherein said third blooming perfume composition is different from said first blooming perfume composition, and wherein said third blooming perfume composition is different from said second blooming perfume composition.

14. A dryer-added fabric conditioning article comprising:
a) a friable perfume microcapsu Ic; and
b) a formaldehyde scavenger.

15. The dryer-added fabric conditioning article of claim 14, further comprising from about 0.001% to about 99.99% by weight of said dryer-added fabric conditioning article, of a fabric conditioning composition.

16. The dryer-added fabric conditioning article of claim 15, wherein said fabric conditioning composition comprises from about 0.00 1% to about 99.99% by weight of said fabric care composition, of one or more fhbric conditioning actives.

17. The dryer-added fabric conditioning article of claim 15, further comprising:
a) from about 10 mg to about 100 mg of said friable perfume microcapsule;
b) from about 0.01% to about 0.8% by weight of said fabric conditioning composition, of said fonnaldehyde scavenger.

18. The dryer-added fabric conditioning article of claim 14, further comprising
a) from about 15% to about 40% by weight of said dryer-added bbric conditioning article, of a fabric conditioning composition;
b) from about 40 mg to about 100 mg of said friable perfume microcapsule; and
c) from about 0.065% to about 0.25% by weight of said fabric conditioning composition, of said formaldehyde scavenger.

19. The dryer-added fabric conditioning article of claim 16, wherein said one or more fabric conditioning actives comprise a fabric softening active

20. The dryer-added fabric conditioning article of claim 16, wherein said one or more fabric conditioning actives comprise an antistatic active.

21. The dryer-added fabric conditioning article of claim 14, wherein said friable perfume microcapsule comprises:
a) a first blooming perfume composition encapsulated in a first friable perfume microcapsule;
b) optionally, a second blooming perfume composition encapsulated in a second friable perfume microcapsule, wherein said first blooming perfume composition is different from said second blooming perfume composition; and
c) optionally, a third blooming perfurnc composition encapsulated in a third friable perfume microcapsule, wherein said third blooming perfume composition is different from said first blooming perfume composition, and wherein said third blooming perfume composition is different from said second blooming perfume composition.

22. A method of treating fabric comprising the step of administering an article of claim 1 to a laundry tumble dryer and/or an automatic laundry dryer.

23. A method of treating fabric comprising the step of administering an article of claim 14 to a laundry rumble dryer and/or an automatic laundry dryer.
